(19) United States
(12) Patent Application Publication
(10) Pub. No.: US 2026/0249252 A1
(43) Pub. Date: Aug. 27, 2026

(54) DEVICES AND METHODS FOR REMOVING METAL CATIONS FROM FLUIDS

(71) Applicant: CITY UNIVERSITY OF HONG KONG, Kowloon (HK)

(72) Inventors: Zhiyuan ZENG, Kowloon (HK); Liang MEI, Kowloon (HK)

(21) Appl. No.: 19/060,530

(22) Filed: Feb. 21, 2025

(51) Int. Cl. B01D 69/14; B01D 67/00; B01D 71/02; B01J 20/02; B01J 20/28; B01J 20/30; C02F 1/28; C02F 1/44; C02F 101/20

(52) U.S. Cl. CPC B01D 69/147; B01D 67/00416; B01D 71/0221; B01J 20/0211; B01J 20/0214; B01J 20/0218; B01J 20/0285; B01J 20/28033; B01J 20/3085; C02F 1/281; C02F 1/44; C02F 2101/20

(57) ABSTRACT

Disclosed herein are methods and devices for removing metal cations from fluid. The method includes filtering the fluid through a membrane, which includes a polymeric substrate and a plurality of 1T/1T′—transition metal dichalcogenide (TMD) nanosheets disposed thereon. The membrane is capable of reducing the concentration of the metal cations in the fluid from about 2 parts per million (ppm) to below 10 parts per billion (ppb). Also disclosed herein is a device for removing metal cations from a fluid. The device includes the present membrane described above, in which the membrane is capable of reducing the concentration of the metal cations in the fluid from about 2 ppm to below 10 ppb.

### BACKGROUND OF THE INVENTION

### 1. Field of the Invention

The present invention relates to methods and devices for the removal of metal cations by the use of 1 T/1 T′-phase transition metal dichalcogenide (TMD) nanosheets.

### 2. Description of Related Art

Heavy metal ions (HMIs) in drinking water poses a grave threat to human health owing to their inherent characteristics of high toxicity, rapid mobility, and non-biodegradability. Among the various HMIs, lead ions (Pb²⁺), cadmium ions (Cd²⁺), and mercury ions (Hg²⁺) warrant particular concern due to their well-documented detrimental effects. Although, numerous technologies have been applied for removing these ions, including chemical precipitation, solvent extraction, ion exchange, and membrane separation, their removal efficiency is not sufficient to meet the stringent requirements of extremely low HMI concentrations in drinking water (World Health Organization (WHO) guideline values are 10 ppb, 3 ppb and 6 ppb for Pb²⁺, Cd²⁺ and Hg²⁺, respectively).

Adsorption stands out as an effective strategy for the HMIs decontamination from drinking water because of its exceptional uptake capacity, remarkable selectivity, rapid kinetics as well as straightforward operation and regeneration. Although many materials (especially two-dimensional (2D) materials, such as, hexagonal boron nitride (h-BN), graphene oxide (GO), transition metal carbide/nitride (MXene), transition metal dichalcogenides (TMDs)) have been developed for HMI removal, they each face challenges, including but not limiting to, low capacity, poor selectivity, slow kinetics, and high residual of Pb²⁺ concentrations.

In view of the above, there exists in the related art a need of an improved method and/or device for reducing the concentration of metal cations in fluid to a level that meets the value (<10 ppb) required by the WHO guidelines.

### SUMMARY

Embodiments of the present disclosure relate to methods of removing metal cations from a fluid, particularly, heavy metal cations in drinking water.

The first objective of the present disclosure aims to provide a method of removing metal cations from fluid. The method includes filtering the fluid through a membrane, wherein the membrane comprises a polymeric substrate and a plurality of 1 T/1 T′-transition metal dichalcogenide (TMD) nanosheets disposed thereon, and the membrane is capable of reducing the concentration of the ions in the fluid from about 2 parts per million (ppm) to below 10 parts per billion (ppb).

According to embodiments of the present disclosure, the metal cations are selected from the group consisting of sodium ions, potassium ions, magnesium ions, calcium ions, copper ions, nickel ions, lead ions, zinc ions, and a combination thereof. In certain embodiments, the metal cations are copper ions and lead ions. In other embodiments, the metal cations are zinc ions, copper ions and lead ions.

According to embodiments of the present disclosure, the membrane is produced by a method comprising steps of:
(i) discharging a bulk TMD in a lithium battery to produce a lithiated bulk TMD;
(ii) subjecting the lithiated bulk TMD to sonification in water to exfoliate the lithiated bulk TMD into the plurality of 1 T/1 T′-TMD nanosheets;
(iii) collecting the product of step (ii) by centrifugation;
(iv) re-dispersing the product of step (iii) in water to produce a suspension of 1 T/1 T′-TMD nanosheets; and
(v) vacuum-filtrating the suspension of 1 T/1 T′-TMD nanosheets onto the polymeric substrate thereby producing the membrane.

Examples of the polymeric substrate suitable for use in the present disclosure include, but are not limited to, nylon, poly(vinylidene fluoride) (PVDF), and the like.

Examples of the 1 T/1 T′-TMD nanosheets suitable for use in the present disclosure include, but are not limited to, 1 T/1 T′-MoS₂ nanosheets, 1 T/1 T′-WS₂ nanosheets, 1 T-TaS₂ nanosheets, and 1 T-TiS₂ nanosheets. Preferably, the 1 T/1 T′-TMD nanosheets are 1 T′-MoS₂ nanosheets.

According to embodiments of the present disclosure, the 1 T/1 T′-TMD nanosheets have an adsorption capacity from about 175 mg/g to about 530 mg/g for the lead ions. In one embodiment, the adsorption capacity for the 1 T′-MoS₂ nanosheets is about 530 mg/g. In another embodiment, the adsorption capacity for the 1 T′-WS₂ nanosheets is about 330 mg/g. In further embodiment, the adsorption capacity for the 1 T-TaS₂ nanosheets is about 175 mg/g. In still further embodiment, the adsorption capacity for the 1 T-TiS₂ nanosheets is about 390 mg/g.

The second objective of the present disclosure aims to provide a device for removing metal cations from fluid. The device is characterized in having a membrane capable of reducing the concentration of the metal cations in the fluid from about 2 ppm to below 10 ppb, wherein the membrane comprises a polymeric substrate, and a plurality of 1 T/1 T′-TMD nanosheets disposed thereon.

According to embodiments of the present disclosure, the metal cations are selected from the group consisting of sodium ions, potassium ions, magnesium ions, calcium ions, copper ions, nickel ions, lead ions, zinc ions, and a combination thereof. In certain embodiments, the metal cations are copper ions and lead ions. In other embodiments, the metal cations are zinc ions, copper ions and lead ions.

According to embodiments of the present disclosure, the membrane is produced by a method comprising steps of:
(i) discharging a bulk TMD in a lithium battery to produce a lithiated bulk TMD;
(ii) subjecting the lithiated bulk TMD to sonification in water to exfoliate the lithiated bulk TMD into the plurality of 1 T/1 T′-TMD nanosheets;
(iii) collecting the product of step (ii) by centrifugation;
(iv) re-dispersing the product of step (iii) in water to produce a suspension of 1 T/1 T′-TMD nanosheets; and
(v) vacuum-filtrating the suspension of 1 T/1 T′-TMD nanosheets onto the polymeric substrate thereby producing the membrane.

Examples of the polymeric substrate suitable for use in the present disclosure include, but are not limited to, nylon, PVDF, and the like.

Examples of the 1 T/1 T′-TMD nanosheets suitable for use in the present disclosure include, but are not limited to, 1 T/1 T′-MoS₂ nanosheets, 1 T/1 T′-WS₂ nanosheets, 1 T-TaS₂ nanosheets, and 1 T-TiS₂ nanosheets. Preferably, the 1 T/1 T′-TMD nanosheets are 1 T′-MoS₂ nanosheets.

According to embodiments of the present disclosure, the 1 T/1 T′-TMD nanosheets have an adsorption capacity from about 175 mg/g to about 530 mg/g for the lead ions. In one embodiment, the adsorption capacity for the 1 T′-MoS₂ nanosheets is about 530 mg/g. In another embodiment, the adsorption capacity for the 1 T′-WS₂ nanosheets is about 330 mg/g. In further embodiment, the adsorption capacity for the 1 T-TaS₂ nanosheets is about 175 mg/g. In still further embodiment, the adsorption capacity for the 1 T-TiS₂ nanosheets is about 390 mg/g.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1 is a flow chart illustrating steps of a method 10 for producing the present membrane in accordance with one embodiment of the present disclosure;

FIG. 2a to 2f are bar or line graphs depicting the removal of various cations by TMD nanosheets of Example 1, in which panels 2a, 2b, 2c, 2d, removal percentage of various cations by exfoliated TMD (i.e., MoS₂, WS₂, TaS₂, TiS₂) nanosheets in individual ion solution of 2 mg/L; 2e, isotherm of Pb²⁺ adsorption by TMD nanosheets; 2f, kinetic curves of Pb²⁺ adsorption by TMD nanosheets;

FIG. 3a is a bar graph depicting residual Pb²⁺ concentration in solution after standing for 24 hr. in accordance with Example 2 of the present disclosure; and

FIG. 3b is a bar graph depicting the corresponding Pb²⁺ removal efficiency by TMD nanosheets of Example 1 after standing for 24 hr.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

The first objective of the present disclosure is directed to a method of removing metal cations from fluid, particularly removing heavy metal cations (e.g., copper and lead ions) from the fluid by filtering through a membrane.

According to embodiments of the present disclosure, the membrane comprises, in its structure, a polymeric substrate and a plurality of 1 T/1 T′-TMD nanosheets disposed on the polymeric substrate, in which the 1 T/1 T′-TMD nanosheets are capable of adsorbing metal cations from fluid thereby may reduce the concentration of the metal cations in the fluid to a low level of 2 ppb.

The term “1 T/1 T′-TMD nanosheets” as used herein refers to TMD nanosheets independently exists in 1 T-phase or 1 T′-phase. Accordingly, the 1 T/1 T′-TMD nanosheets may be 1 T-TMD nanosheets, or 1 T′-TMD nanosheets.

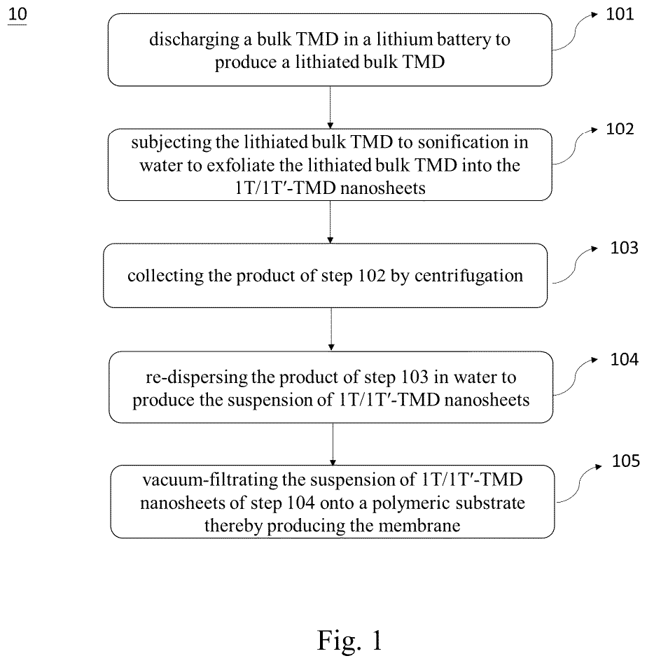

In order to produce the desired membrane, 1 T/1 T′-TMD nanosheets are produced by electrochemical lithium intercalation followed by exfoliation in water, detail steps are described in the flowchart in FIG. 1. To this purpose, a lithium battery for performing the method 10 described in the flowchart is constructed. Specifically, a slurry containing bulk TMD powders, carbon black, and polyvinylidene difluoride (PVDF) are mixed with N-methyl pyrrolidone (NMP) to give a mixture, which is fabricated into a cathode. The cathode is assembled with an anode (i.e., a lithium foil), and an electrolyte into the lithium battery, and a potential difference is applied to the battery to intercalate lithium ions into the cathode. According to embodiments of the present disclosure, the lithium battery is discharged at a constant current of 0.025-0.1 mA and a cut off voltage of 0.7-0.9 V thereby producing a lithiated bulk TMD (FIG. 1, step 101). The lithiated bulk TMD is then subjected to sonification in water so as to exfoliate the lithiated bulk TMD into 1 T/1 T′-TMD nanosheets (FIG. 1, step 102). According to embodiments of the present disclosure, the exfoliated 1 T/1 T′-TMD nanosheets are mono- or bi-layer, metallic (1 T/1 T′ phase), and negatively charged. The thus produced 1 T/1 T′-TMD nanosheets of step 102 are subsequently collected via centrifugation (FIG. 1, step 103). To produce the present membrane, the 1 T/1 T′-TMD nanosheets of step 103 are re-dispersed in water to give a suspension of 1 T/1 T′-TMD nanosheets (FIG. 1, step 104).

According to embodiments of the present disclosure, examples of the 1 T/1 T′-TMD nanosheets suitable for use in the present disclosure include, but are not limited to, 1 T/1 T′-MoS₂ nanosheets, 1 T/1 T′-WS₂ nanosheets, 1 T-TaS₂ nanosheets, and 1 T-TiS₂ nanosheets. Preferably, the 1 T/1 T′-TMD nanosheets are 1 T′-MoS₂ nanosheets.

According to embodiments of the present disclosure, the 1 T/1 T′-TMD nanosheets could adsorb metal cations thereon, thus are useful for removing metal cations from fluids contaminated with metal cations. According to embodiments of the present disclosure, the fluid may comprise metal cations that are selected from the group consisting of sodium ions, potassium ions, magnesium ions, calcium ions, copper ions, nickel ions, lead ions, zinc ions, and a combination thereof. In certain embodiments, the fluid may comprise copper ions and lead ions. In other embodiments, the fluid may comprise zinc ions, copper ions and lead ions.

According to embodiments of the present disclosure, the present 1 T/1 T′-TMD nanosheets exhibit superior affinity toward lead ions with K_{d} values of about 5.57×10⁷, 3.59×10⁷, 3.9×10⁷, and 1.8×10⁷ mL/g for the 1 T′-MoS₂, 1 T′-WS₂, 1 T-TaS₂, and 1 T-TiS₂ nanosheets, respectively. According to embodiments of the present disclosure, the present 1 T/1 T′-TMD nanosheets have an adsorption capacity of about 175-530 mg/g for the lead ions, in which the concentration of lead ions in a fluid may be reduced from 2 mg/L to below 10 μg/L in a period of 1 to 4 min. In one embodiment, the adsorption capacity for the 1 T′-MoS₂ nanosheets is about 530 mg/g. In another embodiment, the adsorption capacity for the 1 T′-WS₂ nanosheets is about 330 mg/g. In further embodiment, the adsorption capacity for the 1 T-TaS₂ nanosheets is about 175 mg/g. In still further embodiment, the adsorption capacity for the 1 T-TiS₂ nanosheets is about 390 mg/g.

The suspension of 1 T/1 T′-TMD nanosheets of step 104 are further collected onto a polymeric substrate via vacuum filtration thereby producing the desired membrane (FIG. 1, step 105). Examples of the polymeric substrate suitable for use in the present disclosure include, but are not limited to, nylon, PVDF, and the like. According to preferred embodiment of the present disclosure, the suspension of 1 T/1 T′-TMD nanosheets of step 104 are collected onto PVDF via vacuum filtration. The thus produced membrane could then be used to construct a point-of-use (POU) device for the removal of metal cations from fluid.

Accordingly, the second objective of the present disclosure aims to provide a device for removing metal cations from fluid. The device is characterized in having the membrane described above, which comprises a polymeric substrate and a plurality of 1 T/1 T′-TMD nanosheets disposed on the polymeric substrate, and is capable of reducing the concentration of the metal cations in the fluid from about 2 ppm to below 10 ppb.

Examples of the 1 T/1 T′-TMD nanosheets suitable for use in the present disclosure include, but are not limited to, 1 T/1 T′-MoS₂ nanosheets, 1 T/1 T′-WS₂ nanosheets, 1 T-TaS₂ nanosheets, and 1 T-TiS₂ nanosheets. Preferably, the 1 T/1 T′-TMD nanosheets are 1 T′-MoS₂ nanosheets. According to preferred embodiments of the present disclosure, the membrane has a thickness of about 500 nm of 1 T′-MoS₂ nanosheets disposed on a polymeric substrate of PVDF.

According to embodiments of the present disclosure, the fluid may comprise metal cations that are selected from the group consisting of sodium ions, potassium ions, magnesium ions, calcium ions, copper ions, nickel ions, lead ions, zinc ions, and a combination thereof. In certain embodiments, the fluid comprises metal cations that are copper ions and lead ions. In other embodiments, the fluid comprises metal cations that are zinc ions, copper ions and lead ions.

According to embodiments of the present disclosure, the membrane is capable of removing 100% of lead ions, 90% of copper ions and 10-50% of other ions including but not limiting to potassium, sodium, nickel, zinc, calcium, and magnesium ions, from a feed solution with an initial concentration of 2 mg/L.

According to embodiments of the present disclosure, the membrane after adsorbing metal cations or being saturated with the metal cations may be regenerated by repeatedly flushing with a solution containing a chelating agent (e.g., ethylenediamine tetra acetic acid, EDTA). In certain embodiments, the regenerated membrane may still reduce the concentration of metal cations (e.g., lead ions) in a feed solution from 1 mg/L to 10 μg/L or below.

According to further embodiments of the present disclosure, the present membrane is found to be stable in aqueous solution with pH ranging between 0 to 14, in which no significant differences in XRD spectra are observed for each pristine TMD membranes after 3 days' soaking.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### Material and Methods

### Synthesis of Single/Bi-Layer TMD Nanosheets

TMD (e.g., MoS₂, WS₂, TaS₂, or TiS₂) nanosheets were prepared using an electrochemical lithium intercalation-based exfoliation method. Briefly, the slurry containing bulk TMD powder, carbon black, and polyvinylidene difluoride (PVDF) (8:1:1 by weight) mixed with N-Methyl pyrrolidone (NMP) was fabricated into an electrode plate. The plate acted as a cathode and was assembled into a testing coin cell and then discharged to perform the lithium intercalation. The lithium-intercalated cathode (e.g., LiₓMoS₂) was separated from the dissembled cell and subjected to sonication in distilled water for 5-15 minute, during which the generated gas (H₂) bubbles accelerated the exfoliation of the bulk material into nanosheets (e.g., MoS₂ nanosheets). The exfoliated TMD nanosheets were collected by centrifugation and re-dispersed in water. The centrifugation/re-dispersion steps were repeated at least three times to remove multiple layers of TMD nanosheets. Thus, TMD nanosheets were successfully synthesized. The exfoliated TMD nanosheets were subsequently purified through multiple rinses with DI water.

### Synthesis of the TMD Membranes

The purified TMD nanosheets were redispersed in DI water, and subsequently vacuum-filtrated onto a porous polymer substrate (PVDF, 220 nm pore size, 25 mm in diameter) to fabricate the TMD membrane. The thickness of the membrane was precisely tuned by controlling the volume of the filtrated solution.

### Adsorption of Metal Cations by TMD Nanosheets

Batch experiments were conducted to investigate the adsorption of various metal cations onto TMD nanosheets. Nine different metal cations, including Pb²⁺, Cu²⁺, Cd²⁺, K⁺, Ni²⁺, Na⁺, Zn²⁺, Ca²⁺, and Mg²⁺, were evaluated in the form of nitrate salts to eliminate any potential interference from anions. The procedure involved mixing the TMD nanosheets solution with each individual metal cation at a concentration of 2 mg/L, followed by 12 hours of stirring. After this incubation period, the TMD nanosheets with adsorbed cations were separated using 0.22 μm PVDF syringe filters, and the remaining cation concentration in the filtrate solution was determined using Inductively coupled plasma optical emission spectroscopy (ICP-OES, Optima 8000 spectrometer) or Inductively Coupled Plasma Mass Spectrometer (ICP-MS, PE Nexion 2000, used for detecting the concentration of cation with ppb level). The removal rate (R) was calculated using the formula R=[(C₀−C_{f})/C_{f}]×100%, where C₀ and C_{f} represent the initial and final concentrations of the cations (mg/L), respectively. The distribution coefficient (K_{d}) was calculated using the formula K_{d}=[(C₀−C_{f})/C_{f}]V/m, where V represents the volume of the solution (ml) and m denotes the mass of the adsorbent (g). The concentration of TMD nanosheets was determined by digesting the sample in a mixture of HNO₃ and H₂O₂ solution, followed by testing the concentration of soluble Mo/W/Ta/Ti species via ICP-OES. These batch experiments were conducted at room temperature to assess adsorption capacity, selectivity, and kinetic processes. To evaluate adsorption capacity, various concentrations of Pb²⁺ ranging from 2 to 80 mg/L were individually introduced into the TMD nanosheets solution. After 12 hours of continuous stirring, the residual Pb²⁺ concentrations were quantified using ICP-MS. In order to investigate the kinetics of the Pb²⁺ adsorption process, a mixture of TMD with Pb²⁺ at a concentration of 2 mg/L was stirred for varying durations: 1, 2, 4, 8, 16, 30, and 60 min, respectively. Subsequently, the remaining Pb²⁺ concentration was promptly determined using ICP-MS after separating the Pb²⁺ adsorbed TMD nanosheets.

Filtration of Pb²⁺ Through MoS₂ Membrane

The filtration experiment involving Pb²⁺ through the MoS₂ membrane was conducted at room temperature using a pressure cell (Sterlitech) with an internal volume of 300 ml. To initiate the experiment, a MoS₂ membrane (1 cm in diameter) was loaded into the cell's chamber, which was then filled with Pb²⁺ solutions of varying concentrations (1 mg/L and 0.25 mg/L). The filtration experiments were initiated by applying a pressure of 1 bar using compressed N₂. Subsequently, 10 mL samples of the filtrate were periodically collected and subjected to analysis using ICP-MS. To regenerate the TMD membrane after the Pb²⁺ filtration, it was thoroughly flushed with an EDTA solution to remove the adsorbed Pb²⁺ from the membrane. This regenerated membrane was then ready for use in subsequent filtration experiments.

### Example 1: Fabrication and Characterization of TMD Nanosheets

In this example, TMD nanosheets were produced by procedures involving electrochemical lithium intercalation followed by exfoliation in water in accordance with procedures described in the “Materials and methods” section.

Atomic force microscopy (AFM) analysis confirmed these TMD nanosheets including MoS₂, WS₂, TaS₂, and TiS₂ nanosheets were respectively ultrathin (mono- or bi-layer, yield >92%), metallic (1 T/1 T′ phase) and negatively charged. Specifically, 93% of MoS₂ and 92% of TaS₂ were single-layer, while about 92% of WS₂ and 93% of TiS₂ were bi-layered.

### Example 2: Selective Absorption of Metal Ions by TMD Nanosheets of Example 1

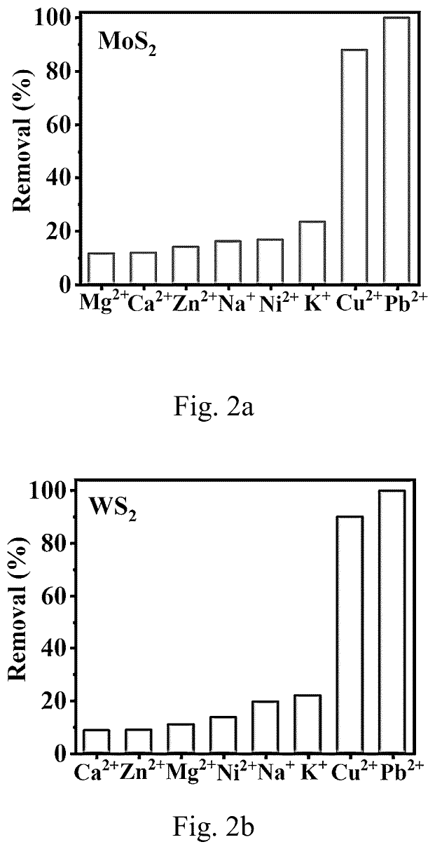

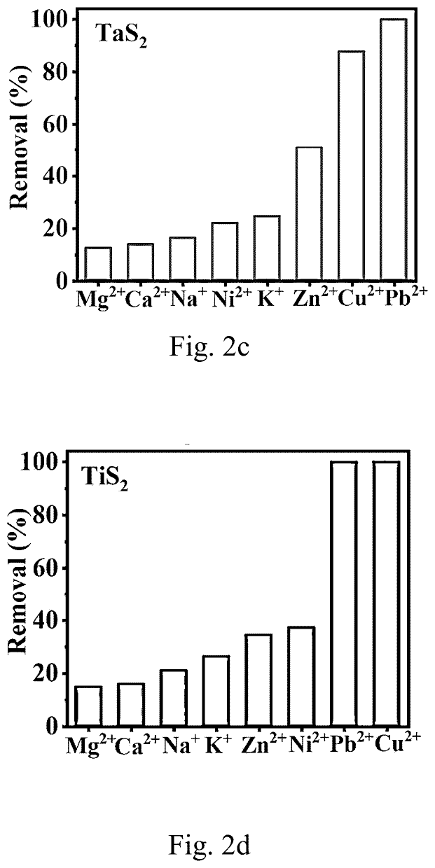

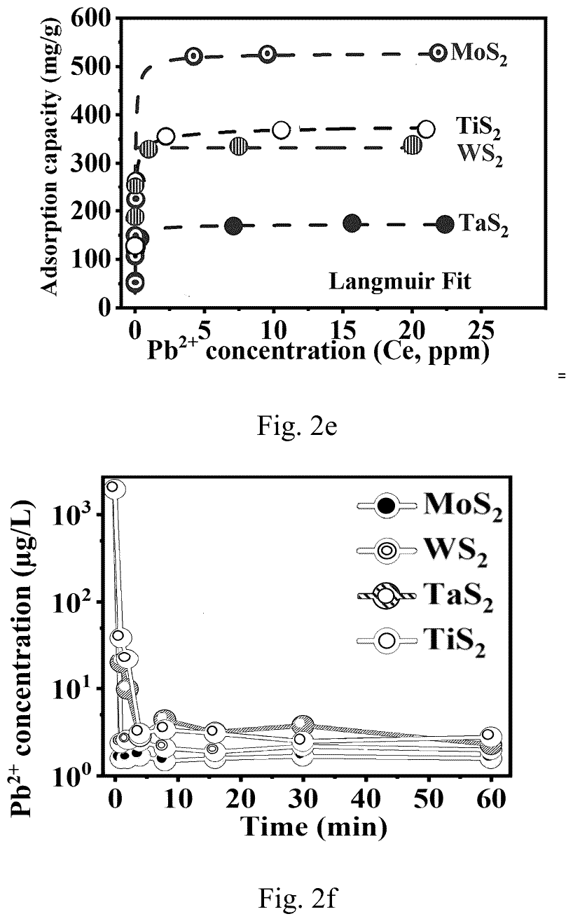

In this example, the ability of TMD nanosheets of Example 1 in removing metal ions, including toxic transition metal cations (e.g., Pb²⁺, Cu²⁺, Ni²⁺ and Zn²⁺) and background cations (e.g., K⁺, Na⁺, Ca²⁺, and Mg²⁺) was investigated in accordance with the procedures described in the “Materials and methods” section. Results are illustrated in FIG. 2 and Tables 1 to 4.

It was found that all of the TMD nanosheets of Example 1 exhibited 100% removal of Pb²⁺ with initial concentration of 2 mg/L (FIGS. 2a, 2b, 2c, 2d). A high removal efficiency was also found for Cu²⁺ (87-90%), but the removal efficiency for K⁺, Na⁺, Ni²⁺, Zn²⁺, Ca²⁺ or Mg²⁺ was very low (about 10-50%) (see Tables 1 to 4). Furthermore, the MoS₂, WS₂, TaS₂, and TiS₂ nanosheets of Example 1 respectively exhibited superior K_{d} values of 5.57×10⁷, 3.59×10⁷, 3.90×10⁷, and 1.58×10⁷ mL/g for Pb²⁺, which were 2 to 4 orders of magnitude higher than those for other metal cations (i.e., Cu²⁺, Zn²⁺, K⁺, Na⁺, Mg²⁺ and Ca²⁺), indicating their superior selectively toward Pb²⁺ (see Tables 1 to 4).

TABLE 1
Absorption of metal cations by MoS₂ nanosheets

| Cation | C₀ (mg/L) | C_{f} (mg/L) | Removal (%) | K_{d} (mL/g) |
|---|---|---|---|---|
| Mg²⁺ | 1.818 | 1.610 | 11.44 | 6.49 × 10³ |
| Ca²⁺ | 1.979 | 1.748 | 11.67 | 7.63 × 10³ |
| Zn²⁺ | 1.904 | 1.640 | 13.87 | 9.29 × 10³ |
| Na⁺ | 2.164 | 1.819 | 15.94 | 1.10 × 10⁴ |
| Ni²⁺ | 1.822 | 1.521 | 16.52 | 1.14 × 10⁴ |
| K⁺ | 2.014 | 1.546 | 23.24 | 1.75 × 10⁴ |
| Cd²⁺ | 2.021 | 1.136 | 43.79 | 4.81 × 10⁴ |
| Cu²⁺ | 2.097 | 0.254 | 87.89 | 4.48 × 10⁵ |
| Pb²⁺ | 1.931 | 0.002 | 99.90 | 5.57 × 10⁷ |

C(MoS₂) = 34.65 mg/L, contact time: 12 hrs.

TABLE 2
Absorption of metal cations by WS₂ nanosheets

| Cation | C₀ (mg/L) | C_{f} (mg/L) | Removal (%) | K_{d} (mL/g) |
|---|---|---|---|---|
| Mg²⁺ | 1.818 | 1.621 | 10.84 | 4.53 × 10³ |
| Ca²⁺ | 1.979 | 1.810 | 8.54 | 3.48 × 10³ |
| Zn²⁺ | 1.904 | 1.737 | 8.77 | 3.58 × 10³ |
| Na⁺ | 2.164 | 1.743 | 19.45 | 9.00 × 10³ |
| Ni²⁺ | 1.822 | 1.576 | 13.50 | 5.82 × 10³ |
| K⁺ | 2.014 | 1.574 | 21.85 | 1.04 × 10⁴ |
| Cd²⁺ | 2.021 | 0.289 | 85.70 | 2.23 × 10⁵ |
| Cu²⁺ | 2.097 | 0.209 | 90.03 | 3.37 × 10⁵ |
| Pb²⁺ | 1.931 | 0.002 | 99.90 | 3.59 × 10⁷ |

C(WS₂) = 53.67 mg/L, contact time: 12 hrs.

TABLE 3
Absorption of metal cations by TaS₂ nanosheets

| Cation | C₀ (mg/L) | C_{f} (mg/L) | Removal (%) | K_{d} (mL/g) |
|---|---|---|---|---|
| Mg²⁺ | 1.818 | 1.595 | 12.27 | 3.43 × 10³ |
| Ca²⁺ | 1.979 | 1.708 | 13.69 | 3.89 × 10³ |
| Zn²⁺ | 1.904 | 0.935 | 50.89 | 2.54 × 10⁴ |
| Na⁺ | 2.164 | 1.815 | 16.13 | 4.71 × 10³ |
| Ni²⁺ | 1.822 | 1.425 | 21.79 | 6.83 × 10³ |
| K⁺ | 2.014 | 1.523 | 24.38 | 7.90 × 10³ |
| Cd²⁺ | 2.021 | 0.001 | 99.95 | 4.95 × 10⁷ |
| Cu²⁺ | 2.097 | 0.260 | 87.60 | 1.73 × 10⁵ |
| Pb²⁺ | 1.931 | 0.003 | 99.84 | 1.58 × 10⁷ |

C(TaS₂) = 81.60 mg/L, contact time: 12 hrs.

TABLE 4
Absorption of metal cations by TiS₂ nanosheets

| Cation | C₀ (mg/L) | C_{f} (mg/L) | Removal (%) | K_{d} (mL/g) |
|---|---|---|---|---|
| Mg²⁺ | 1.818 | 1.550 | 14.74 | 1.05 × 10⁴ |
| Ca²⁺ | 1.979 | 1.667 | 15.77 | 1.13 × 10⁴ |
| Zn²⁺ | 1.904 | 1.251 | 34.30 | 3.16 × 10⁴ |
| Na⁺ | 2.164 | 1.713 | 20.84 | 1.60 × 10⁴ |
| Ni²⁺ | 1.822 | 1.146 | 37.10 | 3.58 × 10⁴ |
| K⁺ | 2.014 | 1.486 | 26.22 | 2.15 × 10⁴ |
| Cd²⁺ | 2.021 | 0.002 | 99.90 | 6.12 × 10⁷ |
| Cu²⁺ | 2.097 | 0.001 | 99.95 | 1.27 × 10⁸ |
| Pb²⁺ | 1.931 | 0.003 | 99.84 | 3.90 × 10⁷ |

C(TiS₂) = 32.99 mg/L, contact time: 12 hrs.

Further, as the cations Na⁺ and Ca²⁺ are ubiquitous in drinking water, the interference of these cations with high concentration on the adsorption capacities of TMD nanosheets toward Pb²⁺ were also investigated. Results showed that 20 mM NaNO₃, 20 mM Ca(NO₃)₂, and laboratory tap water have no detectable impact on TMDs' removal efficiency towards Pb²⁺ (data not shown).

Further experiments were conducted to reveal the underlying adsorption isotherms and kinetics. An adsorption isotherm is a graphical tool representing a dynamic equilibrium between the concentration of remaining metal ions in a bulk solution and the concentration of retained metal ions onto the absorbent (e.g., TMD nanosheets)/solution interface at constant temperature and pH value. As depicted in FIG. 2e, the adsorption isotherms of Pb²⁺ on MoS₂, WS₂, TaS₂ and TiS₂ nanosheets were well fitted with Langmuir model, indicating monolayer Pb²⁺ adsorption on TMD nanosheets. According to this model, MoS₂ nanosheets exhibited a maximum Pb²⁺ adsorption capacity of 529 mg/g, while WS₂, TaS₂, and TiS₂ nanosheets respectively exhibited the adsorption capacity to 332, 175, and 388 mg/g. The kinetic processes for MoS₂, WS₂, TaS₂, and TiS₂ nanosheets in Pb²⁺ adsorption are shown in FIG. 2f. All of the nanosheets exhibited remarkably rapid adsorption kinetics in reducing Pb²⁺ concentrations from an initial level of 2 mg/L to below 10 μg/L with adsorption time of 1, 1, 4, 4 mins, respectively. This performance aligns perfectly with the stringent WHO guideline value for Pb²⁺ concentrations (10 ppb) in drinking water.

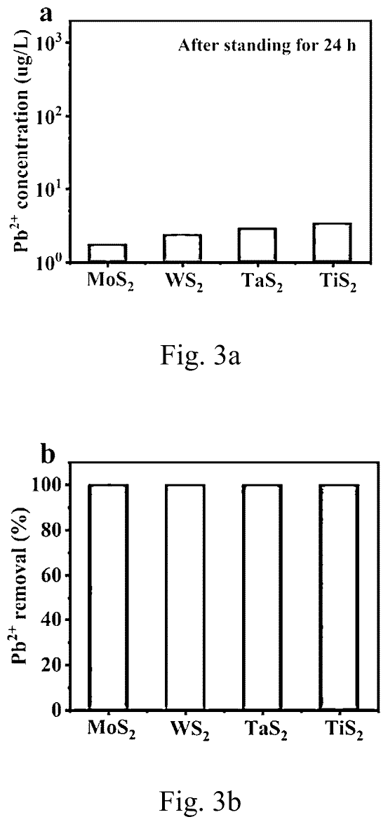

Additionally, the stability of Pb²⁺ adsorption on TMD nanosheets was also investigated, and results indicated that residual Pb²⁺ concentration was very low and below 10 μg/L in each of the four TMD nanosheets (i.e., MoS₂, WS₂, TaS₂ and TiS₂ nanosheets) absorbed solution, suggesting that Pb²⁺ did not leach out of the TMD nanosheets and led to secondary pollution (FIG. 3)

Furthermore, the TMD nanosheets after Pb²⁺ adsorption could be regenerated by use of chelating agents. In this example, ethylenediaminetetraacetic acid (EDTA) was used to treat Pb-adsorbed MoS₂ (MoS₂—Pb) nanosheets, a significant reduction in Pb signal after EDTA treatment was confirmed by X-ray photoelectron spectroscopy (XPS) (data not shown), suggesting successful binding of Pb²⁺ with EDTA. Further results showed that even after 5 generation cycles, the ability of MoS₂ nanosheets to remove Pb²⁺ remained as high as 94% (data not shown).

### Example 3: Portable Point-of-Use (POU) Device for Removal of Pb²⁺ from Drinking Water

In this example, a portable POU device was constructed for the removal of Pb²⁺ from drinking water. To this purpose, MoS₂ nanosheets were selected to construct the POU filter (i.e., a MoS₂ lamellar membrane) due to its superior adsorption capacity and strong affinity for removing Pb²⁺ compared to other TMD nanosheets. The MoS₂ lamellar membrane was fabricated through vacuum filtration in accordance with the procedures described in “Material and method” section.

A layer-by-layer structure of the MoS₂ membrane was clearly visible in scanning electron microscope (SEM) images with a membrane thickness of approximately 500 nm. Pressure-assisted filtration on the MoS₂ membrane was then conducted using feed water with varying Pb²⁺ concentration from 0.25 mg/L to 1 mg/L. It was found that in a feed solution of 1 mg/L Pb²⁺, the effluent volume reached up to 200 mL before Pb²⁺ concentration exceeded 10 μg/L, meeting the WHO guideline value. When concentration of Pb²⁺ in the feed solution was reduced to 0.25 mg/L, the effluent volume could be further increased to 670 mL.

Additionally, the MoS₂ lamellar membrane, after being saturated with Pb²⁺, was regenerated by flushing it with EDTA solution. The regenerated MoS₂ lamellar membrane was subjected to a second filtration cycle and was found to be able to reduce the Pb²⁺ concentration from 1 mg/L to 10 μg/L, with a treatment volume of 184 mL, which was equivalent to 92% of the original value of a fresh MoS₂ lamellar membrane (200 mL). Further, the recovery rate was 97% when the Pb²⁺ concentration decreased from 0.25 mg/L to 10 μg/L (650 mL vs 670 mL). This high recovery rate confirmed the excellent reusability of the MoS₂ lamellar membrane for Pb²⁺ filtration.

The stability of MoS₂ lamellar membrane in aqueous environment was noteworthy. After immersing in water for a month, there was no apparent loosening of the membrane or detachment from the substrate. Similar membrane stability in deionized water was also observed for WS₂, TaS₂, or TiS₂ membranes.

Furthermore, the afore-mentioned TMD membranes were independently soaked in aqueous solution with pH values ranging from 0 to 14 for 3 days, and no significant differences in their XRD spectra were observed between the pristine MoS₂/WS₂/TaS₂/TiS₂ membranes after 72 hr. of soaking, suggesting a well-maintained lamellar configuration, further demonstrating their stable lamellar structure for membrane-based filtration applications under varying pH conditions.

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of removing metal cations from a fluid comprising filtering the fluid through a membrane, wherein the membrane comprises a polymeric substrate and a plurality of 1 T/1 T′-transition metal dichalcogenide (TMD) nanosheets disposed thereon, and the membrane is capable of reducing the concentration of the metal cations in the fluid from about 2 parts per million (ppm) to below 10 parts per billion (ppb).

2. The method of claim 1, wherein the metal cations are selected from the group consisting of sodium ions, potassium ions, magnesium ions, calcium ions, copper ions, nickel ions, lead ions, zinc ions, and a combination thereof.

3. The method of claim 2, wherein the membrane is produced by,
(i) discharging a bulk TMD in a lithium battery to produce a lithiated bulk TMD;
(ii) subjecting the lithiated bulk TMD to sonification in water to exfoliate the lithiated bulk TMD into the plurality of 1 T/1 T′-TMD nanosheets;
(iii) collecting the product of step (ii) by centrifugation;
(iv) re-dispersing the product of step (iii) in water to produce a suspension of 1 T/1 T′-TMD nanosheets; and
(v) vacuum-filtrating the suspension of 1 T/1 T′-TMD nanosheets onto the polymeric substrate thereby producing the membrane.

4. The method of claim 3, wherein
the 1 T/1 T′-TMD nanosheets are 1 T/1 T′-MoS₂ nanosheets, 1 T/1 T′-WS₂ nanosheets, 1 T-TaS₂ nanosheets, or 1 T-TiS₂ nanosheets; and
the polymeric substrate is made of nylon or poly(vinylidene fluoride) (PVDF).

5. The method of claim 4, wherein the 1 T/1 T′-TMD nanosheets have an adsorption capacity of about 175-530 mg/g for the lead ions.

6. The method of claim 5, wherein the 1 T′-MoS₂ nanosheets has the adsorption capacity of about 530 mg/g, the 1 T′-WS₂ nanosheets has the adsorption capacity of about 330 mg/g, the 1 T-TaS₂ nanosheets has the adsorption capacity of about 175 mg/g, and the 1 T-TiS₂ nanosheets has the adsorption capacity of about 390 mg/g.

7. A device for removing metal cations from a fluid comprising a membrane, wherein the membrane comprises a polymeric substrate and a plurality of 1 T/1 T′-TMD nanosheets disposed on the polymeric substrate, and the membrane is capable of reducing the concentration of the metal cations in the fluid from about 2 ppm to below 10 ppb.

8. The device of claim 7, wherein the metal cations are selected from the group consisting of sodium ions, potassium ions, magnesium ions, calcium ions, copper ions, nickel ions, lead ions, zinc ions, and a combination thereof.

9. The device of claim 8, wherein the membrane is produced by,
(i) discharging a bulk TMD in a lithium battery to produce a lithiated bulk TMD;
(ii) subjecting the lithiated bulk TMD to sonification in water to exfoliate the lithiated bulk TMD into the plurality of 1 T/1 T′-TMD nanosheets;
(iii) collecting the product of step (ii) by centrifugation;
(iv) re-dispersing the product of step (iii) in water to produce a suspension of 1 T/1 T′-TMD nanosheets; and
(v) vacuum-filtrating the suspension of 1 T/1 T′-TMD nanosheets onto the polymeric substrate thereby producing the membrane.

10. The device of claim 9, wherein
the polymeric substrate is made of nylon or PVDF; and
the 1 T/1 T′-TMD nanosheets are 1 T/1 T′-MoS₂ nanosheets, 1 T/1 T′-WS₂ nanosheets, 1 T-TaS₂ nanosheets, or 1 T-TiS₂ nanosheets.

11. The device of claim 10, wherein the 1 T/1 T′-TMD nanosheets have an adsorption capacity between about 175 mg/g to about 530 mg/g for the lead ions.

12. The method of claim 11, wherein the 1 T′-MoS₂ nanosheets has the adsorption capacity of about 530 mg/g, the 1 T′-WS₂ nanosheets has the adsorption capacity of about 330 mg/g, the 1 T-TaS₂ nanosheets has the adsorption capacity of about 175 mg/g, and the 1 T-TiS₂ nanosheets has the adsorption capacity of about 390 mg/g.
